(19) United States
(12) Patent Application Publication
(10) Pub. No.: US 2021/0402951 A1
(43) Pub. Date: Dec. 30, 2021

(54) DEFORMABLE BRACING ROD FOR HOLDING A LOWER CROSSMEMBER OF A WINDSHIELD OPENING OF A MOTOR VEHICLE

(71) Applicant: PSA AUTOMOBILES SA, Poissy (FR)

(72) Inventors: Damien BESSETTE, ECOT (FR); Francois VERDIER, ANTONY (FR)

(21) Appl. No.: 17/298,403

(22) PCT Filed: Nov. 22, 2019
(86) PCT No.: PCT/FR2019/052786

§ 371 Date: May 28, 2021

(30) Foreign Application Priority Data
Dec. 6, 2018 (FR) 1872412

(51) Int. Cl. B60R 21/34

(52) U.S. Cl. CPC B60R 21/34; B60R 2021/343

(57) ABSTRACT

A deformable bracing rod is disclosed for holding a lower crossmember of a windshield opening of a motor vehicle. The deformable bracing rod (200) has rigid end portions (203, 204), respectively attached to the windshield opening lower crossmember (301) and to another element (102) of the body of the vehicle, and a flexible central portion (203) connecting the two rigid end portions. It makes it possible to design a collapsible lower crossmember of a windshield opening which yields in the event of an impact so as to damp the impact experienced by the head of a pedestrian, while maintaining the level of acoustic and vibrational performance.

### CROSS-REFERENCE TO RELATED APPLICATIONS

The present application is the US National Stage under 35 USC § 371 of International Application No. PCT/FR2019/052786, filed 22 Nov. 2019 which claims the priority to French application No. 1872412 filed on Dec. 6, 2018, the content of each (text, drawings and claims) being incorporated herein by reference.

### BACKGROUND

The present invention relates generally to the field of the design of motor vehicle body structural elements, and more particularly to the issue of the passive safety of motor vehicles in the event of an impact of the motor vehicle with a pedestrian.

It relates to a deformable bracing rod for holding a lower crossmember of a collapsible windshield opening of a motor vehicle, a set of structural elements of the body of a vehicle comprising such a crossmember thus held, as well as a motor vehicle incorporating such an assembly.

The passive safety of a motor vehicle refers to all the means that are activated in a motor vehicle during an accident in order to minimize the severity for the occupants of the vehicle and/or for people outside the vehicle and involved in the accident.

In addition to the existence of specific safety devices such as, for example, the seat belt, the airbags or the head restraint, passive safety is based on the capacity of the structural elements of a motor vehicle to absorb the energy of an impact when it occurs. This is particularly the case for collisions between the vehicle and a pedestrian. In the event of such a collision, the structure of the vehicle must be capable of deforming so as to absorb the energy throughout the impact, by a programmed deformation, in order to minimize the consequences of the impact for the hit pedestrian.

These safety issues are the subject of strict regulations as well as a detailed examination by the various existing programs for evaluating the safety performance of vehicles. The certification protocol of a motor vehicle in particular requires a large number of tests aimed at checking compliance with standards concerning the damping of an impact of the vehicle with the legs, the femur or even the head of a pedestrian. Likewise, the European EuroNCAP (European New Car Assessment Program) and Chinese ChinaNCAP (China New Car Assessment Program) include impact tests in their assessments of a vehicle with the various parts of the body of a pedestrian who would be struck by the vehicle.

These impact tests generally consist of percussion, by an object faithfully reproducing the behavior of a particular part of a human body, which is launched at a known speed against different areas of the motor vehicle. The term “shots” is used to refer to such tests carried out in practice. The deceleration experienced by the object at the time of impact against the vehicle is measured by an accelerometer integrated into the object. This makes it possible to determine the intensity of this impact for each of the affected areas of the vehicle and/or for each affected part of the human body. In particular, the area under the measured deceleration curve is compared to different threshold values in order to determine whether the vehicle meets the criteria required by the certification protocol and/or can be awarded the maximum possible points as part of an assessment program.

The so-called “pedestrian-head impact” test thus aims, as its name suggests, to test a simulated impact between the head of a pedestrian and a motor vehicle. So far, the performance associated with the impact of a pedestrian's head which is examined both by the certification protocol and by the assessment programs relates only to the impact of a pedestrian's head with the hood of the vehicle.

The stiffness of the material from which the hood is made must therefore allow deformation of the hood, which generates the most progressive possible deceleration of the head of a pedestrian during an impact with this external structural element. But it is also necessary to prevent a structural element of the vehicle which is inherently deformable from deforming suitably during an impact due to its arrangement and/or other surrounding structural elements. Obtaining good performance in terms of passive safety is therefore also based on the appropriate use of so-called “fusible” parts in the impact area considered, that is to say, parts that deform, break or eject during an impact so as not to form a hard spot.

Beginning in 2024, the certification protocol and the assessment programs will introduce new requirements aimed in particular at the impact of the head of a pedestrian. Shots simulating such an impact must be carried out specifically in the area at the bottom of the windshield located, at the front of the vehicle, at the junction between the hood and the windshield. These tests must imperatively lead to results deemed admissible in order to obtain the certification, or to obtain the maximum points during an assessment. In other words, certain biomechanical criteria of a pedestrian impact, which until now have been optional, will probably become essential to pass the certification protocol and/or to obtain good marks in the context of the assessments according to the EuroNCAP and ChinaNCAP programs.

The ability of a motor vehicle to absorb an impact from the head of a pedestrian in the lower windshield area of the vehicle relies in particular on the fact that the lower windshield opening crossmember (LWOC), which is located in this area, can collapse, gradually and without abrupt stopping of this collapse, at the moment of an impact with the head of the pedestrian. Reference is made to a “collapsible” LWOC in the sense that it can collapse under the effect of an impact, in order to dampen the impact by absorbing part of the energy during the impact.

The LWOCs present on current models of motor vehicles are not “collapsible.” They are inherently rigid and are, moreover, supported by mechanical reinforcing parts which themselves are also rigid. These parts are rigidly supported on an element of the vehicle body to constitute an additional reinforcement preventing any collapse of the LWOC in the event of an impact. The existing LWOCs are in fact designed so as to be rigid in order, in particular, to offer good performance in terms of minimizing the vibrations potentially transmitted by the LWOC from the engine compartment to the interior of the passenger compartment. They are then said to offer a good acoustic and vibratory performance (ACV). However, they are not compatible with the aforementioned future standards in terms of passive safety, which should soon be imposed by the certification protocol and/or the assessment programs for motor vehicles.

Document FR 2892079 discloses a hood structure which allows the hood to collapse, in the rear area of the hood, at the junction with the windshield, so as to close the separation gap between these two elements and thus avoid causing even greater damage to the pedestrian in the event of an impact. However, the targeted collapse is that of the hood and not that of the lower windshield opening crossmember. The latter therefore remains rigid and liable to cause a sudden deceleration of the head of a pedestrian during an impact.

### SUMMARY OF THE INVENTION

The invention aims to eliminate, or at least mitigate, all or part of the aforementioned drawbacks of the prior art.

To this end, a deformable bracing rod is provided for holding a lower crossmember of a windshield opening of a motor vehicle, the deformable bracing rod having a first end portion, a second end portion and a central portion which extends longitudinally between the first end portion and the second end portion, the bracing rod comprising:
a deformable blade extending in the longitudinal direction of the bracing rod, in the central portion of the bracing rod, from the first end portion to the second end portion of the bracing rod;
a first reinforcing plate, with a flat portion extending substantially parallel to the blade at the first end portion of the bracing rod and with flanged edges by which it is connected to the blade at the first end portion of the bracing rod to form a first stiffening box with the blade, the first plate being adapted to be connected to the crossmember by the face of its flat portion which is opposite the blade;
a second reinforcing plate, with a flat portion extending substantially parallel to the blade at the second end portion of the bracing rod and with flanged edges by which it is connected to the blade at the second end portion of the bracing rod to form a second stiffening box with the blade, the second plate being adapted to be connected to another structural element of the motor vehicle body by the face of its flat portion which is opposite the blade;

wherein:
the flat portions of the first and second reinforcing plates extend in two distinct respective planes; and
the blade is substantially flat in the central portion of the bracing rod, and extends in a plane which is not parallel to the plane in which the flat portion of at least one of the first and second plates extends, so that, during a collapse of the lower crossmember of the windshield opening following an impact, the deformable bracing rod bends at the junction between the corresponding end portion and the central portion of the bracing rod.

Due to the invention, it is possible to hold a lower windshield opening crossmember (LWOC) in a manner which makes it possible both to limit, in normal operation, the transmission of acoustic waves and of engine vibrations from the engine of the vehicle to the LWOC, on the one hand, and to absorb an impact by the head of a pedestrian in the area of this LWOC, on the other hand. The assembly formed by a LWOC made of a relatively flexible material so that the LWOC and held by the deformable bracing rods as described indeed leads to a progressive deceleration of the head of a pedestrian in the event of an impact in this area, avoiding the collision of the head with a hard and non-deformable element. In other words, it allows the LWOC to be collapsible.

Embodiments of the bracing rod, taken alone or in combination, further provide that:
the blade has, in the central portion of the bracing rod, a width variation area adapted so that, when the lower windshield opening crossmember collapses following an impact, the deformable bracing rod bends at the blade width variation area;
the flat portion of at least one of the first and second reinforcing plates comprises:
   a rib which extends in a direction parallel to the longitudinal direction of the bracing rod, from an edge of the plate which is contiguous to the central portion of the blade and over a determined portion only of the length of the plate in the longitudinal direction; and
   an area in the extension of the rib, to receive an electrical welding point for connecting the bracing rod with the lower windshield opening crossmember or with the other element of the body of the motor vehicle, respectively;
the blade and the reinforcing plates of the bracing rod are made of a flexible metal alloy, and wherein the blade and/or the reinforcing plates of the bracing rod have a thickness of approximately 1 millimeter; and
the variation of the width of the central blade, in the width variation area, takes place linearly in the longitudinal direction of the blade, according to a V-shaped profile ranging from the widest to the narrowest.

The use of a bracing rod as described above to hold the LWOC of a motor vehicle makes it possible to make the LWOC collapsible in order to meet future passive safety requirements relating to impact with the head of a pedestrian, while maintaining the same level of ACV benefits.

This is why, in a second aspect relates to a set of structural elements of the body of a motor vehicle comprising a collapsible lower windshield opening crossmember and at least one deformable bracing rod according to the first aspect above, for holding the crossmember to another structural element of the body.

Embodiments taken alone or in combination further provide that:
the other structural element of the body of the motor vehicle to which the lower windshield opening crossmember is held by means of the bracing rod is an upper fire wall of the body;
the assembly further comprises a cowl collector, and the position of the width variation area of the blade of the bracing rod in the longitudinal direction of the blade is adapted to avoid bracing between the deformable bracing rod and the upper part of the cowl collector during a collapse of the lower windshield opening crossmember following an impact; and
the collapsible lower windshield opening crossmember is made of a metal alloy and has a thickness of less than 1 millimeter, for example equal to approximately 0.95 millimeters.

A final aspect relates to a motor vehicle comprising at least one set of structural elements according to the second aspect above.

### BRIEF DESCRIPTION OF THE FIGURES

Other features and advantages of the invention will become apparent on reading the description which follows. This is purely illustrative and should be read in conjunction with the accompanying drawings, in which:

FIG. 1 is a perspective view of a lower windshield opening crossmember held by support pieces according to the prior art;

FIG. 2 is a perspective view of embodiments of a deformable bracing rod;

FIG. 3 is a perspective view of an example of the use of bracing rods such as the bracing rod of FIG. 2, to hold a windshield opening crossmember on a body structure element of a motor vehicle; and

FIG. 4 is a schematic illustration of the results of a modeling illustrating the evolution, during an impact with the head of a pedestrian, of the deformation of a LWOC held by a deformable bracing rod according to FIG. 2.

### DESCRIPTION OF THE EMBODIMENTS

In the description of embodiments which will follow and in the figures of the accompanying drawings, the same elements or similar elements bear the same reference numerals in the drawings.

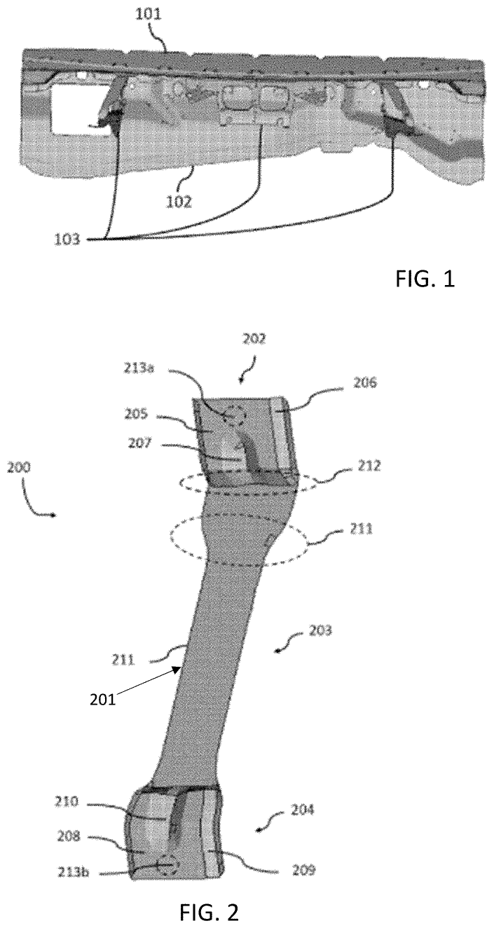

FIG. 1 shows, in perspective, a lower windshield opening crossmember (LWOC) of a motor vehicle, which is held by support parts according to the prior art. As already stated in the background, this crossmember 101 is designed to be rigid so as, in particular, not to transmit acoustic waves and vibrations from the engine compartment to the passenger compartment. As a result, it cannot collapse on impact in order to absorb impact energy. This rigid LWOC is supported by equally rigid mechanical parts, namely retaining brackets 103 in the example shown, which rest on another structural element of the body of the motor vehicle. More precisely, in the example shown, the brackets 103 bear on the upper fire wall 102 of the motor vehicle. The LWOC is not, in fact, liable to collapse under the effect of an impact and therefore cannot dampen, if necessary, the impact of the head of a pedestrian striking this area of the vehicle. The design and arrangement of all of these parts therefore prevent any deformation of the structure of the vehicle in this area of the vehicle, in the event of an impact with the head of a pedestrian.

FIG. 2 shows, in perspective, the embodiments of a deformable bracing rod 200, which it will then be seen allows the production of a collapsible LWOC.

In a particular embodiment, the deformable bracing rod 200 comprises a blade 201 which is made of a metal alloy such as, for example, flexible steel. The thickness of the blade 201 is, for example, equal to 1 millimeter. This relatively small thickness makes it possible in particular to locally obtain a capacity for deformation of the bracing rod at the blade, to which we will return later. This thickness value is purely indicative. In other embodiments, moreover, the bracing rod can be made of synthetic material. However, the use of a plastic material capable of withstanding the cataphoresis process and of exhibiting the characteristics suitable for the desired deformation results in a high cost of materials and a high manufacturing cost. This is why an embodiment made from a metal alloy is preferable.

The blade 201 of the bracing rod 200 has a longitudinal direction which, in FIG. 2, is oriented substantially vertically. In addition, the upper elements of the bracing rod are located at the top and the lower elements are located at the bottom in FIG. 2. In what follows, the terms “vertical” and “horizontal,” “(on) top” and “(on) bottom,” “upper,” and “lower,” etc., are used in reference to this illustration of the bracing rod.

The deformable bracing rod 200 comprises a central portion 203 which is flexible, and two end portions which are rigid, namely an upper end portion 202 and a lower end portion 204, respectively. These end portions 202 and 204 are suitable for and intended for attaching the bracing rod to the structural elements of the vehicle body that the bracing rod helps to assemble and hold together.

In the illustrated example, the central portion 203 of the bracing rod 200, between the end portions 202 and 204, only comprises the flexible blade 201. This central portion 203 can therefore be the threshold of a deformation, as will be explained in what follows.

The upper end portion 202 of the deformable bracing rod 200 comprises the upper end of the blade 201. It also comprises a reinforcing plate 205 which is for example substantially rectangular and extends in a vertical plane, parallel to the plane of the blade 201 in this end portion 202 of the bracing rod. The width of the plate 205, along the horizontal, corresponds substantially to the width of the blade 201 locally. The plate 205 for example has flanged edges 206, which extend longitudinally along the vertical in the configuration shown in FIG. 2. The flanged edges 206 correspond to a curvature or a fold of the vertical edges of the plate 205. They are oriented horizontally, toward the blade 201, substantially perpendicular to the plane of the plate 205 and of the blade 201 in this end portion 202 of the bracing rod. In other words, the curvature or fold of the edges 206 of the plate 205 gives this part a “U”-shaped section in a horizontal plane. The base of this “U,” which corresponds to the flat portion of the plate 205, is adapted to be attached, for example by welding, to a first structural element of the vehicle to which the bracing rod 200 is attached by its upper end 202. For this purpose, the face of the plate 205 which is opposite the face of the blade 201 and which is visible in FIG. 2 comprises an area 213a for receiving an electrical welding spot (EWS). The two branches of the “U,” which correspond to the flanged edges 206 of the plate 205, are substantially orthogonal to the plane of the flat portion of said plate 205, and orthogonal to the blade 201 in the upper end portion 202 of the bracing rod 200. Thus, in this upper end portion of the bracing rod 200, the blade 201 closes the box formed by the flat portion of the plate 205 and its two flanged edges 206. The plate 205 is assembled by welding the ends of the flanged edges 206 to the blade 201 of the bracing rod 200.

This shape and arrangement of the plate 205 impart rigidity to the upper end portion 202 of the bracing rod 200, to prevent any local deformation. Thus, the upper end portion 202 of the bracing rod 200 is suitable for rigidly attaching the bracing rod to a first structural element of the motor vehicle.

In some embodiments, the planar base of the plate 205 also comprises a rib 207, which is centered along the horizontal between its two flanged edges 206, and which extends vertically upward, from the lower edge of the plate 205, over a determined portion of the height of the plate along the vertical. The rib 207 imparts rigidity to the plate 205, in order to limit its capacity for deformation. In one example, the area 213a provided to receive the EWS is located just above the upper end of the rib 207, in the extension of the rib.

The lower end portion 204 of the deformable bracing rod 200 also comprises a reinforcing plate 208, symmetrically comparable to the reinforcing plate 205 of the upper end portion 202. In particular, the plate 208 is substantially rectangular, with flanged edges 209 which are orthogonal to the plane and the flat plate area and which extend horizontally toward the blade 201 in the lower end portion 204 of the bracing rod 200.

Furthermore, the end portion 204 of the bracing rod 200 also comprises a rib 210, centered along the horizontal between the flanged edges of the plate 208, and which extends vertically downward, from the upper edge of the plate 208, over a determined portion of its height. In the same way as for the upper portion 202, the flat face of the plate 208 is intended to come into contact with another element of the vehicle to which the bracing rod 200 is attached by its lower end 204, and for this purpose comprises an area 213b to receive another EWS. This area 213b can be located just below the lower end of the rib 210, in the extension of said rib.

In summary, all the elements which form the upper 202 and lower 204 portions of the deformable bracing rod 200 impart rigidity to these portions, unlike the central portion 203, which retains the flexible and deformable nature specific to the blade 201.

Conversely, in fact, the blade 201 remains flexible in its central portion 203, that is to say between the end portions 202 and 204, which extends longitudinally (i.e., along its length) between the upper end portion 202 and the lower end portion 204 of the deformable bracing rod 200. In order to maintain this flexibility and its total deformation capacity, it preferably comprises no flanged edges, ribs or reinforcements.

In addition, the flat faces of the plates 205 and 208 of the two end portions 202 and 204, respectively, extend in respective planes, namely vertical planes which are parallel to each other in the example considered here and shown in FIG. 2, but distinct. The central portion of the blade extends in its longitudinal direction at a slight angle with respect to the respective planes of the plates 205 and 208 of the end portions 202 and 204, respectively, of the bracing rod 200. Thus, a force applied vertically to the bracing rod 200 via one or the other of its end portions 202 and 204 has the effect of causing the deformation, in particular buckling, of the central portion 203 of the bracing rod, which is flexible because it only comprises the flexible blade 201.

This design of the bracing rod, combining the rigidity of the end portions 202 and 204 and the flexibility of the central portion 203, plays a determining role (which will be explained later) in the behavior of the bracing rod in the event of a collapse of the LWOC that it supports, a collapse caused for example by an impact with the head of a pedestrian.

In one embodiment, the blade 201 in the central portion 203 of the bracing rod may locally have a width variation area 211. In the non-limiting example which is shown in FIG. 2, it is a linear variation in the longitudinal direction of the blade, according to a V-shaped profile, ranging for example from the widest to the narrowest from the upper portion toward the lower portion of the blade 201. The role of this width variation area 211, which will be explained later with reference to FIG. 4, is to create a break in inertia which allows a programmed deformation of the central portion 203 of the blade of the bracing rod 201.

To fulfill its role of maintaining a LWOC, the deformable bracing rod is securely attached to the LWOC, on the one hand, and to another element of the motor vehicle body, on the other hand. As already mentioned above, the deformable bracing rod 200 is welded to the LWOC by its upper end portion 202, and to a second structural element of the chassis of the motor vehicle by its lower end portion 204. In a particular embodiment, this second structural element is the upper fire wall 102 of the chassis of the motor vehicle.

In a particular embodiment, the attachment of the deformable bracing rod 200 with the lower windshield opening crossmember and with another structural element of the chassis of the motor vehicle is obtained by two electrical welding spots (EWS). These two EWSs are located respectively on the flat portion of the plate 205 of the upper end portion 202 (at the area 213a) and on the flat portion of the plate 208 of the lower end portion (at the area 213b), above or below, respectively, ribs 207 and 210, respectively, of the plates 205 and 208, respectively. Such attachments at a single point make it possible to situate this point in a particularly reinforced area (owing to the rib). This prevents the attachments from breaking during an impact and allows better control of the location where the deformation(s) of the bracing rod will occur, if necessary. Alternatively, it may be an attachment by screw or bolt, or by any other suitable attachment means.

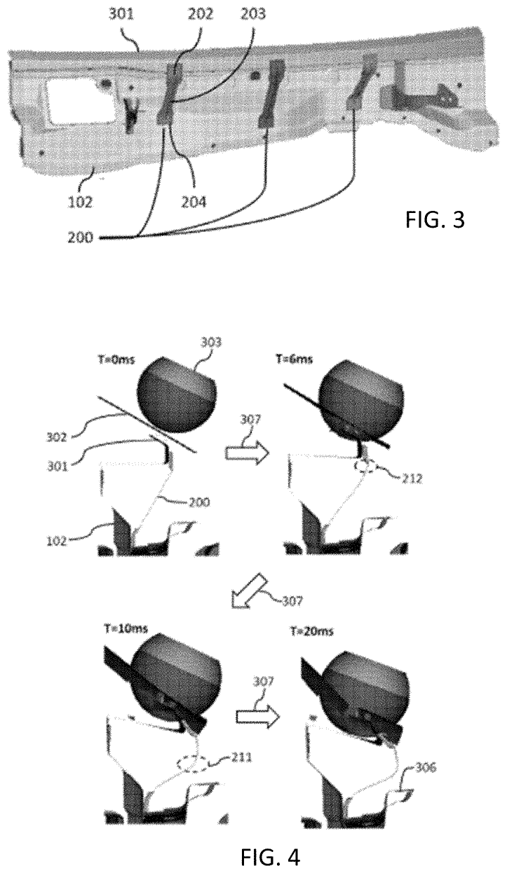

FIG. 3 shows an example of the use of bracing rods conforming to the bracing rod 200 of FIG. 2. More specifically, the figure illustrates an embodiment of a set of structural elements of the chassis of a motor vehicle which comprises a lower windshield opening crossmember 301 and three deformable bracing rods 200 which hold this LWOC. The bracing rods hold the LWOC to another structural element of the vehicle chassis, for example to the upper fire wall 102 in the example shown. This element separates the engine compartment from the vehicle interior. In FIG. 3, the LWOC and its retaining bracing rods are seen from the engine compartment.

The LWOC is designed to be inherently deformable, due to its low thickness. In one example, the LWOC is made of a metal alloy, for example of steel, and has a thickness reduced to approximately 1 mm, for example 0.95 mm, in order to give it good bending capacity. The reinforcements of the LWOC are also reduced to what is strictly necessary to guarantee good flexibility of the LWOC in the event of an impact with the head of a pedestrian. In general, the geometry of the LWOC is such that it can, in itself, collapse and not create a hard spot, while being favorable to compliance with the constraints of acoustic and vibratory filtration (known as ACV).

The bracing rods 200 have the function of maintaining the LWOC while preventing it from transmitting vibrations from the engine to the passenger compartment. The bracing rods are arranged on the side of the engine compartment. The fact that the bracing rods are themselves deformable makes it possible to obtain flexibility in the connection between the LWOC and the upper fire wall 102. The LWOC thus designed and maintained becomes collapsible, which will allow vehicles to be certified when the new passive safety requirements come into force.

In summary, owing to its flexible design and its holding by the proposed deformable bracing rods, the LWOC can advantageously not only collapse under the effect of an impact so as to absorb the impact, but it is also held firmly enough to make it possible to limit the transmission to the passenger compartment of acoustic waves and vibrations from the vehicle engine. The use of such an assembly therefore does not entail any additional acoustic or vibratory nuisance compared to the prior art in which the LWOC is rigid and non-deformable.

Those skilled in the art will appreciate that the number of deformable bracing rods used, as well as their arrangement and their distribution along the LWOC, can be chosen in order to optimize the compromise between the holding of the LWOC by the bracing rods, which guarantees compliance with the ACV constraints on the one hand, and the damping effect of an impact with the head of a pedestrian in the area of the LWOC on the other hand, depending on the specific characteristics of each application.

With reference to FIG. 4, a sequence of images will now be described illustrating the deformation as a function of time of a LWOC held by a deformable bracing rod according to FIG. 2 at the time of an impact with the head of a pedestrian. These images correspond to the results obtained from a finite element calculation method making it possible to model the behavior of the various mechanical parts involved, under the effect of such an impact.

The four images shown in FIG. 4 illustrate the chronological evolution of the state of each element, respectively at the initial instant (0 milliseconds), that is to say, at the precise moment when the impact of the head of a pedestrian with the area of the LWOC occurs, then respectively at 6, 10 and 20 milliseconds (ms) after this impact. This chronological development takes place in the order indicated by arrows 307 in FIG. 4.

At the instant t=0 (at the top left of FIG. 4), the head of a pedestrian 303 strikes the windshield 302 supported by the lower windshield opening crossmember 301, which is in turn held by the deformable bracing rod 200 visible in the figure. The arrangement of the rigid end portions and of the flexible central portion of the bracing rod, and the fact that the upper and lower portions are located in two distinct planes parallel to each other, cause a first deformation of the bracing rod. Additionally, the fact that the central blade of the bracing rod locally has a width variation area causes a second programmed deformation of the bracing rod, with a bending of the blade 201 at a specific location along its longitudinal direction. Indeed, as illustrated by the images at t=6 ms and at t=10 ms respectively, the central portion 203 of the blade 201 of the deformable bracing rod 200 bends, firstly, at the junction 212 and between its upper end portion 202 and this central portion 203, and secondly, at the width variation area 211 of the blade 201 under the effect of the impact with the head of the pedestrian.

Those skilled in the art will appreciate that it is the variations in the stiffness of the bracing rod at the junction between the upper end portion and the central area of the bracing rod on the one hand, and at the width variation area of the blade in the central portion of the bracing rod, on the other hand, which make it possible to anticipate the precise places where the bracing rod bends and therefore the way in which it deforms. Reference is thus made to a break in inertia between these different portions of the bracing rod. In the illustrated example, the width variation area 211 of the blade 201 in the central portion 203 of the bracing rod 200 is located at two-thirds of the length of the blade starting from its lower end portion, in the upper half of the central portion of the bracing rod. It is the variation in rigidity provided by the variation in the width of the blade 201 at the area 211 which causes the bending of the blade in this area precisely. However, those skilled in the art will appreciate that the position of this area can be changed to program the deformation of the bracing rod by adapting it to the actual space in which it is to be installed, in order to prevent its deformation from being limited by contact with a surrounding structural element of the vehicle chassis, or by one of the vehicle equipment items present in the engine compartment.

Those skilled in the art will also appreciate that the LWOC used in this context is a LWOC which itself is designed to be flexible enough to be able to be crushed in response to impact. In one embodiment, the LWOC is made from a steel 0.95 millimeters thick, which is small enough to allow its deformation. In FIG. 4, the collapse of the LWOC is visible from the instant t=6 ms, and is accentuated at t=10 ms, then again at t=20 ms. Thus, owing to the combined effect of the crushing of the LWOC on itself and the deformation of the bracing rod allowing the collapse of the LWOC, it is possible to gradually decelerate the head which is impacted against the LWOC.

In addition, those skilled in the art will know how to adapt the deformable bracing rod to prevent bracing between the deformable bracing rod and another structural element of the chassis of the motor vehicle during a collapse of the lower windshield opening crossmember. Such bracing can in fact occur, for example, between the deformable bracing rod and the upper part of a cowl collector 306 of the chassis. This element of the vehicle body structure has the function, as those skilled in the art are aware, of collecting and discharging the rainwater which flows from the windshield. In other words, the dimensions and shape of the bracing rod are adapted to prevent, during its deformation following a collapse of the LWOC, a part of the bracing rod from coming to rest on the upper portion of the cowl collector, which could stop its deformation. This makes it possible to guarantee the free deformation of the LWOC and thus to prevent the head of a pedestrian, in its deceleration phase, from encountering a rigid element which cannot be deformed and which would cause sudden deceleration, and therefore potentially significant trauma to the pedestrian. This result can be obtained, in particular, owing to a choice of the length of the central portion 203 of the bracing rod and to a suitable positioning of the width variation area 211 of this blade 201 in the central portion 203 of the bracing rod (see FIG. 2). Of course, several width variation areas of the blade, such as area 211 of FIG. 2, can be provided to obtain more complex deformation scenarios, according to the specific features of each use case.

The sizing of bracing rods in accordance with embodiments as described in the foregoing makes it possible to propose a collapsible LWOC to withstand the so-called “pedestrian-head” impact, but also to satisfy the ACV constraints. Indeed, the attachment of the LWOC by these bracing rods makes it possible to improve the acoustics in the bottom area of the windshield and provides a certain torsional stiffness, which reduces the transmission of vibratory phenomena.

The bracing rod has been described and illustrated in the present detailed description and in the figures of the accompanying drawings, in possible embodiments. The bracing rod is not, however, limited to the embodiments presented. Other variants and embodiments can be deduced and implemented by a person skilled in the art on reading the present description and the accompanying drawings.

In the claims, the term “comprising” or “including” does not exclude other elements or other steps. The different features which are presented and/or claimed can be advantageously combined. Their presence in the description or in different dependent claims does not exclude this possibility. The reference signs cannot be understood as limiting the scope of the invention.

1. A deformable bracing rod for holding a lower windshield opening crossmember of a motor vehicle, said deformable bracing rod having a first end portion, a second end portion and a central portion which extends longitudinally between the first end portion and the second end portion, said bracing rod comprising:
a deformable blade extending in the longitudinal direction of the bracing rod in the central portion of the bracing rod from the first end portion to the second end portion of the bracing rod;
a first reinforcing plate, with a flat portion extending substantially parallel to the blade at the first end portion of the bracing rod and with flanged edges by which it is connected to the blade at the first end portion of the bracing rod to form a first stiffening box with said blade, said first plate being adapted to be connected to the crossmember by the face of its flat portion which is opposite the blade;
a second reinforcing plate, with a flat portion extending substantially parallel to the blade at the second end portion of the bracing rod and with flanged edges by which it is connected to the blade at the second end portion of the bracing rod to form a second stiffening box with said blade, said second plate being adapted to be connected to another structural element of the body of the motor vehicle by the face of its flat portion which is opposite the blade;
wherein:
the flat portions of the first and second reinforcing plates extend in two separate respective planes; and
the blade is substantially flat in the central portion of the bracing rod, and extends in a plane which is not parallel to the plane in which the flat portion of at least one of the first and second plate extends, so that, during a collapse of the lower windshield opening crossmember following an impact, the deformable bracing rod bends at the junction between the end portion and the central portion of the bracing rod.

2. The deformable bracing rod according to claim 1, wherein the blade has, in the central portion of the bracing rod, a width variation area adapted so that, when the lower windshield opening crossmember collapses following an impact, the deformable bracing rod bends at said width variation area of the blade.

3. The deformable bracing rod according to claim 1, wherein the flat portion of at least one of the first and second reinforcing plates comprises:
a rib which extends in a direction parallel to the longitudinal direction of the bracing rod, from an edge of the plate which is contiguous to the central portion of the blade and over a determined portion only of the length of the plate in said direction; and
an area in the extension of the rib, to receive an electrical welding spot for the connection of the bracing rod with the lower windshield opening crossmember or with the other element of the body of the motor vehicle, respectively.

4. The deformable bracing rod according to claim 1, wherein the blade and the reinforcing plates of the bracing rod are made of a flexible metal alloy, and wherein the blade and/or the reinforcing plates of the bracing rod have a thickness of approximately 1 millimeter.

5. The deformable bracing rod according to claim 2, wherein the variation of the width of the central blade, in the width variation area, takes place linearly in the longitudinal direction of the blade, according to a V-shaped profile ranging from the widest to the narrowest.

6. A set of structural elements of the body of a motor vehicle comprising a collapsible lower windshield opening crossmember and at least one deformable bracing rod (200) according to claim 1 for holding said crossmember to another structural element (102) of the body.

7. The set of structural elements according to claim 6, wherein the other structural element of the body of the motor vehicle to which the lower windshield opening crossmember is held by means of the bracing rod is an upper fire wall of the body.

8. The set of structural elements according to claim 6, further comprising a cowl collector, and wherein the position of the width variation area of the blade of the bracing rod in the longitudinal direction of said blade is adapted to avoid bracing between the deformable bracing rod and the upper part of the cowl collector during a collapse of the lower windshield opening crossmember following an impact.

9. The set of structural elements according to claim 6, wherein the collapsible lower windshield opening crossmember is made of a metal alloy and has a thickness of less than 1 millimeter, for example equal to approximately 0.95 millimeters.

10. A motor vehicle comprising at least one set of structural elements according to claim 6.
